(19) United States
(12) Patent Application Publication
(10) Pub. No.: US 2017/0364381 A1
(43) Pub. Date: Dec. 21, 2017

(54) DATA CENTER CONFIGURATION

(71) Applicant: Hewlett Packard Enterprise Development LP, Houston, TX (US)

(72) Inventors: Bobby Brad Suber, Austin, TX (US); Russell Nelson Briggs, Palo Alto, CA (US)

(73) Assignee: Hewlett Packard Enterprise Development LP, Houston, TX (US)

(21) Appl. No.: 15/538,703

(22) PCT Filed: Jan. 13, 2015
(86) PCT No.: PCT/US15/11198

§ 371 Date: Jun. 22, 2017

(51) Int. Cl. G06F 9/455; G06F 15/16; G06F 9/44; G06F 11/08

(52) U.S. Cl. CPC G06F 9/45558; G06F 11/08; G06F 15/16; G06F 9/4401; G06F 9/45541; G06F 2009/45575

(57) ABSTRACT

Example implementations relate to data center configuration. For example, a server system is configured in a data center by a configuration system including an input processor that receives a data file having multiple record types including a range record type. An error checking processor verifies that the data file has correct syntax and that each of the multiple record types is a valid record type with required attributes. If no error is detected, a record processor converts each of the record types in the data file into a set of ReST API and an output processor sends the set of ReST API requests to a data center configuration manager.

### BACKGROUND

Distributed service applications are hosted in cloud-computing networks in one or more datacenters and are intended to promote high availability through redundancy of service-application components, dynamic scalability, and auto-healing functionality. The service applications may be broken up into various service components, including storage, application computing, network services, file systems, databases, streaming services, and the like. These components may be based on either physical or virtual machines and networks and may expand over many datacenters in various geographic locations. As the options and capabilities of these cloud-based datacenters grow and as applications become more complex, the ability of datacenter Administrators to translate the requirements into a configuration of available components is becoming ever more complex, thus delaying deployment times.

### BRIEF DESCRIPTION OF THE DRAWINGS

The disclosure is better understood with reference to the following drawings. The elements of the drawings are not necessarily to scale relative to each other. Rather, emphasis has instead been placed upon clearly illustrating the examples described in the disclosure. Furthermore, like reference numerals designate corresponding similar parts through the several views.

FIG. 1 is a block diagram of an example computer system for implementing a configuration utility;

FIG. 2A is an example of a simple datacenter configuration;

FIG. 2B is an example block diagram of a datacenter configuration manager as shown in FIG. 2A which provides ReST API interfaces;

FIG. 3 is an example flow chart of a method to process a configuration data file with a configuration utility;

FIG. 4 is an example flow chart of a routine to process a validated configuration data file;

FIG. 5 is a set of example range type elements which further simplify configuration with the configuration utility; and

FIGS. 6A and 6B are an example data file format, illustrating syntax, structure, and human-readability. A more complete listing for several of the configuration options is provided in the appendix as a further example.

FIG. 6C is an example description of a logical interconnect group. A listing of the generated ReST API payload is found in the appendix.

### DETAILED DESCRIPTION

Most modern datacenters implementing cloud services have one or more management applications in which to configure various computing, storage, network, and other resources. Often times, these datacenter infrastructure management systems are web-based or command line oriented and require manual entry by system Administrators. Some management applications for datacenter or cloud services, such as Hewlett Packard, Amazon, Google, and Microsoft have a ReST (REpresentational State Transfer) Application Program Interface (API) that enables custom integrations and automation. ReST is an architectural style, and an approach to communications that is often used in the development of Web services. Some ReST APIs requires writing or using a provided server program (to serve data) and a client program (to request data). ReST API payloads (alternatively calls) may be done from a variety of tools and almost any programming language, including cURL (a common tool available on many Linux® platforms), Windows® Power Shell, Python, Ruby, Perl, and or other tools that support making calls to HTTP servers.

It is simply too difficult and time intensive to set up large data center instances where there are hundreds or thousands of computers over various networks and protocols by either manual web-based or command line configuration tools. Using a program to automate and interface with a ReST API requires the Administrator have good programming and debugging skills, and an understanding of the various systems, databases, networks and computer resources. Further, a computer program needs to be maintained over time and future Administrators may not be familiar with the particular programming language used. Also, often times, the syntax of the programming language or its function's calls vary over various revisions making it even more difficult to provide long-term support for when datacenter configuration changes are needed.

The inventors' insight is that rather than write or modify a program each time a datacenter configuration is required, one out-of-the-box appliance program (a boot-strap configuration utility or BSCU) that accepts a simple human readable flat data file that describes the desired datacenter configuration would provide a platform independent, data driven solution that provides an Administrator an easy and flexible way to interface with a ReST interface. Accordingly, a data file with minimal set of information is edited by the Administrator using most any computing platform. This human readable data file is then processed by the out-of-the-box appliance BSCU program using the claimed subject matter to configure a data center instance with ReST API payloads. This BSCU program may contain additional software to allow the data file to be error checked, parsed, and converted to ReST API statements that are then sent to a datacenter configuration manager implementing a ReST API protocol.

This new BSCU datacenter infrastructure management technique allows for increased speed of configuration as well as less chance of making errors in the configuration as the solution provides the Administrator similar functionality for which they are accustomed to and is very protective of the datacenter in the case of errors. In fact, setup may only occur once the configuration data file is error checked to ensure that proper syntax is used, that required attributes necessary for the ReST API are present, and that the various supplied record types are correct. As such, extremely complicated resources in a datacenter can be configured with just a few lines of text thereby increasing the productivity and accuracy of data center Administrators. In addition, being a simple human readable text file, this new technique also allows for quick employment of similar configurations by re-using the data file and only changing a few lines of text. No programming skills by an Administrator are required thus allowing for less technical skills and lower employment costs and the possibility of sourcing the work to a larger community of Administrators.

The basic steps that would now be required by an Administrator are a) create a configuration file that models the available and desired datacenter resources; b) have the BSCU appliance program read, process the configuration file, translate, and send ReST API payloads to the datacenter configuration ReST interface; and c) verify that the configuration is correct by reviewing a report generated from the BSCU appliance program. The configuration data file is a fundamental component that provides the Administrator with the capability of quickly and accurately describe the resources required. The BSCU appliance program handles the often monotonous, technically arduous, and frequently error-prone steps of creating ReST API payloads, particularly when hundreds or thousands of servers, networks, databases, email systems, storage systems, mobile communication interfaces, and the like need to be configured to operate as a cooperating system. With this new technique created by the inventors, the configuration of large datacenter instances can be done within minutes, rather than hours or days, thereby significantly decreasing the overall deployment time.

Programming for a ReST API is complex and requires many considerations. Because of such complexity, many ReST APIs are presented to users via a graphical web-based interface (a web-API). For instance, usually a web-API is characteristically designed for transaction-based applications. This is typical of an intranet application in which users fill out forms and browse data. All the application logic is implemented inside small transactions that receive the user input and return some data. The data is intended for the user's immediate consumption. Also, in some low to medium volume situations, a web-API may be used to implement database rule actions. However, there are several restrictions with web-API implementations that make it technically arduous when used in several scenarios, particularly for setting up large volume situations.

Fortunately, an extensive number of ReST APIs exist in at least one example, the HP OneView® appliance. Requests for these functions can be issued by any client, not just a browser web-API. OneView® ReST APIs are fully documented in the HP OneView® ReST API reference which can be found at http://h20564.www2.hp.com/hpsc/doc/public/display?docId=emr_na-c03967142 (fetched Dec. 25, 2014). While the following examples are discussed in relation to interfacing with an HP OneView® ReST API interface for ease of understanding, the claimed subject matter is not intended to be so limiting. Because each company or organization's data center ReST API interfaces will necessarily have different syntax or calling functions, it is nearly impossible to cover all possible current and future ReST API interface examples. Accordingly, the claimed subject matter is intended to apply to all current and future datacenter or cloud-based computing ReST API interfaces, including but not exclusively limited to the HP OneView® ReST API.

Consequently, rather than having to consider multiple programming related and other issues in creating a program to configure large datacenter instances, the inventors' insight is to have a single BSCU appliance program address these issues and allow an Administrator to just provide details of the desired configuration in a text-based human readable data file rather than having to understand the ReST API documentation and its complex formatting for ReST API payload calls and/or one or more programming languages. More particular details of how to make and use the claimed subject matter follow.

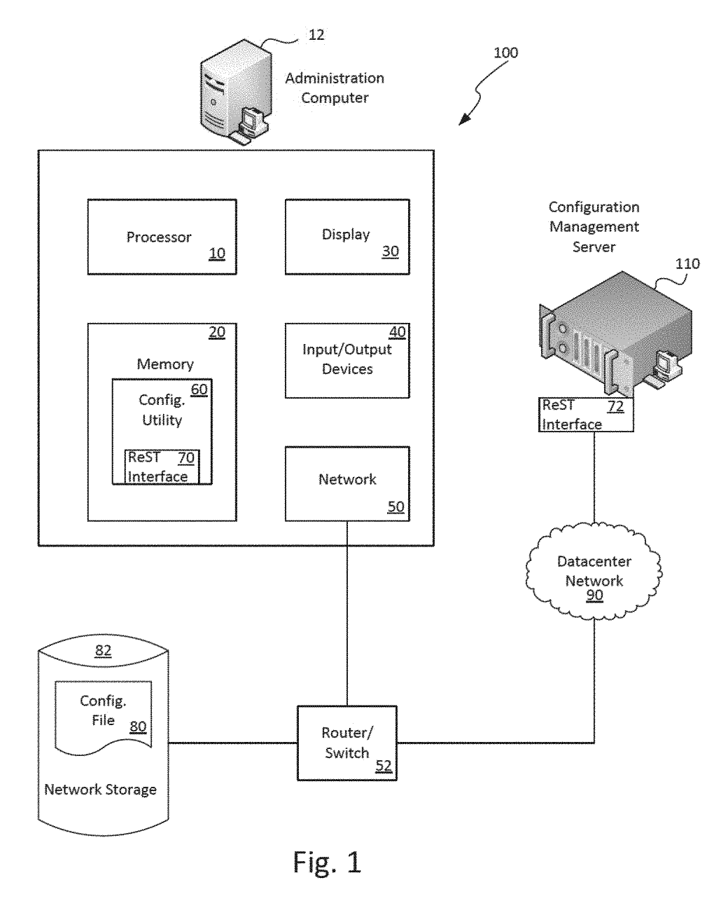

Referring initially to FIG. 1 in particular, an example operating environment for implementing examples of the present BSCU appliance program is shown and designated generally as computing device 100, such as an administration computer 12 which may be any client device. Computing device 100 is but one example of a suitable computing environment and is not intended to suggest any limitation as to the scope of use or functionality of the claimed subject matter. Neither should the computing device 100 be interpreted as having any dependency or requirement relating to any one or combination of components illustrated.

The BSCU appliance program may be described in the general context of non-transitory computer code or machine-useable instructions, including computer-executable instructions such as program modules or logic, being executed by a computer or other machine, such as a personal data assistant or other handheld device. Generally, program modules including routines, programs, objects, components, data structures, etc., refer to code that performs particular tasks or implements particular abstract data types. The BSCU appliance program may be practiced in a variety of system configurations, including handheld devices, consumer electronics, general-purpose computers, more specialty computing devices, etc. The BSCU appliance program may also be practiced in distributed computing environments where tasks are performed by remote-processing devices that are linked through a communications network.

With reference to FIG. 1, computing device 100 includes one or more communication channels or busses that directly or indirectly couples the following devices: memory 20, one or more processors 10, one or more displays 30, input/output (I/O) devices 40, and one or more network or other communication devices 50. Various combinations of the blocks shown may be integrated into common blocks. Accordingly, such is the nature of the art, and FIG. 1 is merely illustrative of an exemplary computing device that can be used in connection with one or more embodiments of the present BSCU appliance program. Distinction is not made between such categories as “workstation,” “server,” “laptop,” “handheld device,” etc., as all are contemplated within the scope of FIG. 1 and reference to a “computing device.” Computing device 100 typically includes a variety of computer-readable media.

Computer-readable media can be any available non-transitory media that can be accessed by computing device 100 and includes both volatile and nonvolatile media, removable and non-removable media. By way of example, and not limitation, computer-readable media may comprise computer storage media and communication media. Computer storage media include both volatile and nonvolatile, removable and non-removable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information and which can be accessed by computing device 100. Communication media typically embody transitory computer-readable instructions, data structures, program modules, or other data in a modulated data signal such as a carrier wave or other transport mechanism and include any information delivery media. However, once received, stored, and used, the communication media becomes non-transitory. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media.

Memory 20 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 20 or I/O devices 40. Display(s) 30 present data indications to a user or other device. Example display components include a display device, speaker, printing component, vibrating component, etc.

I/O devices 40 allow computing device 100 to be logically coupled to other devices, some of which may be built in. Illustrative components include a keyboard, a mouse, a trackpad, a microphone, joystick, game pad, satellite dish, scanner, printer, wireless device, etc.

Network 50 allows computing device 100 to communicate with other computing devices 10 including a datacenter configuration management server 110 through one or more intranet, Internet, private, custom, or other communication channels whether wireless, wired, optical, or other electromagnetic technique. In this example, network 50 connects to a router/switch 52 that is further connected to a network storage 82 that holds one or more configuration data files 80, and a datacenter network 90. The configuration data files 80 may also be stored locally in computing device 100 in the memory 20, a local storage device (not shown), such as a disk drive or solid state drive. Configuration data file 80 may also be stored on the configuration management server 110, particularly while being processed or simply for record keeping.

Configuration data file 80 may be implemented using one or more mark-up languages such as XML, HTML (including HTML5, XHTML, SGML, HTML 2.0, 3.2, 4.0, 4.01, 5, ISO HTML, HTML DTD, HTML+, HTML 3.0, XHTML 1.0, 1.1, 2.0, 5.1 as just a few examples). Other scripting languages may also be used. Several different datacenter configurations may be specified in the configuration data file 80 including appliance, vmwareconfigs, adapters, sslconfig, timeconfig, localeconfig, licenses, users, conntemplates, networks, networkranges, fcnetworks, fcnetworkranges, networksets, networksetranges, enclosures, uplinksets, fcuplinksets, uplinksetranges, ranges, profiles, enclosuregroups, and ligs just to name a few.

Memory 20 may include computer readable instructions to implement the BSCU appliance program 60 locally. In such a situation, the BSCU appliance program 60 may include a ReST interface 70 used to communicate with one or more complementary ReST interface(s) 72 implemented by configuration management server 110. Optionally, the BSCU appliance program 60 and its ReST interface 70 may be resident within the datacenter network 90, such as on the configuration management server 110 or other dedicated server within the datacenter.

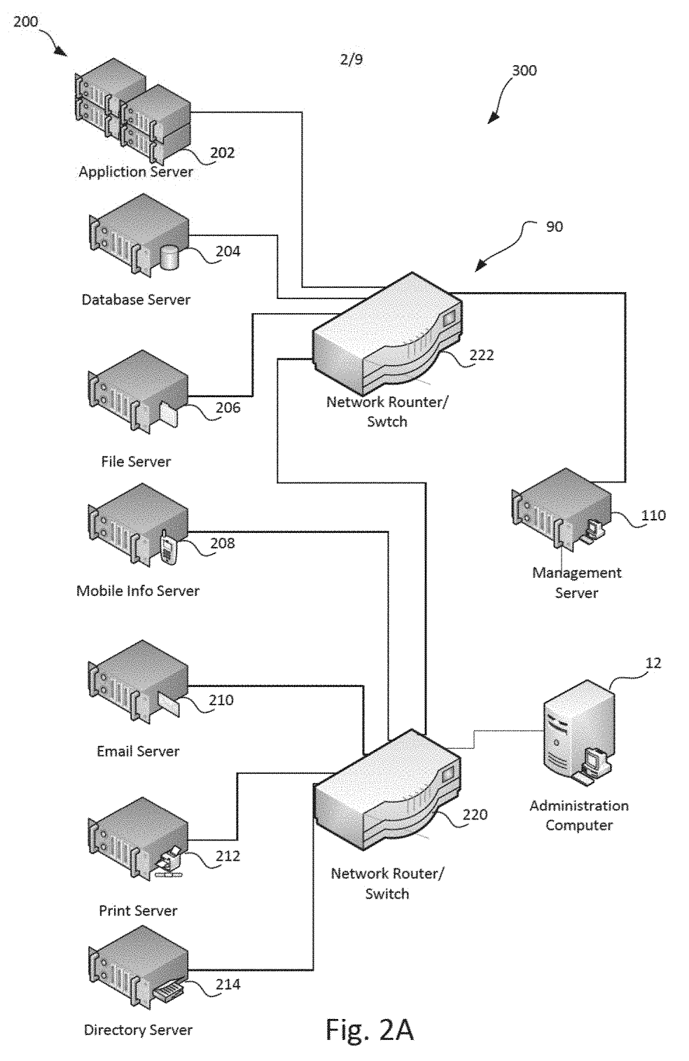

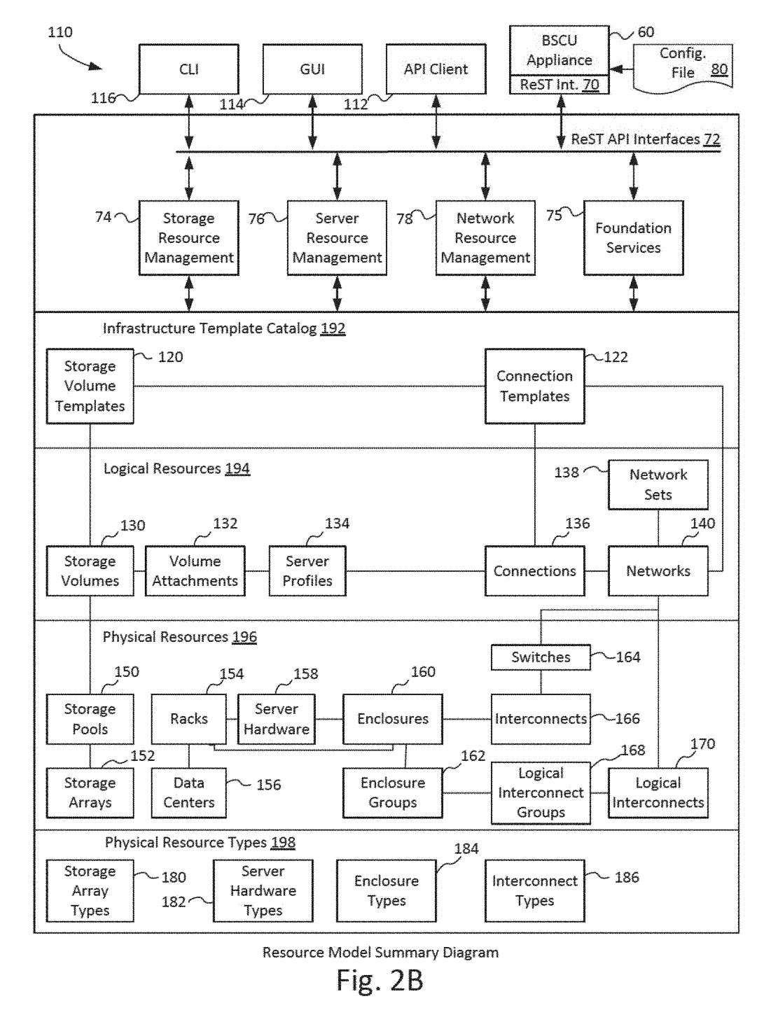

FIG. 2A is an example of a desired cooperating datacenter configuration instance 300 of one or more servers such as one or more application servers 202 (including running one or more web-based applications), database servers 204, file servers 206, mobile information servers 208, email servers 210, print servers 212, directory servers 214, and configuration management server 110, as just a few examples. Those of skill in the art are aware there are several other types of servers, virtual machines, containers, and other devices that can run operating systems and various application programs. The data center configuration instance 300 also includes datacenter network 90 having one or more network connections between the various servers using one or more routers and/or switches 220, 222 and other network connection appliances. The networks may also be implemented using hardware or software to create virtual networks to make configuration of various network parameters more versatile than if only implemented in hardware. The various servers, networks, storage devices, and other datacenter resources may be listed in an availability directory from which the Administrator can select the various components. In other situations, the datacenter resources may be composed of software objects that can be created using existing datacenter hardware resources, such as virtual machines, virtual networks, and virtual storage systems. These then are created as needed by the Administrator when editing the BSCU data file and having it processed by the datacenter configuration manager 110.

FIG. 2B is an example resource model summary diagram of datacenter configuration manager (DCM) 110 in FIG. 2A. DCM 110 may include one or more of multiple methods or techniques for configuring the ReST API interfaces 70 and includes several logical and physical resource models. These include a command line interface (CLI) 116, a Graphical User Interface (GUI) 114, an API client interface 112, and the boot-strap configuration utility (BSCU) appliance 60 which receives and processes flat configuration data file 80. Alternatively, these techniques may reside on other client hardware which accesses the ReST API interfaces 70. The ReST API interfaces 70 are a set of various ReST API functions typically grouped into functional organizations such as Storage Resource Management 74, Server Resource Management 76, Network Resource Management 78, and Foundation Services 75. Foundation Services 75 are ReST API functions which deal with the administration of the Datacenter that does not fall into the storage, server, or network functions. Such Foundation Services 75 include power, cooling, storage arrays, enclosures, switches for LANs and SANs, and level 4 to level 7 Net services. The functional organization ReST API groups each communicate with various datacenter hardware, firmware, and software configurations. For instance, there are Infrastructure Template Catalogs 192 that include Storage Volume Templates 120 and Connection Templates 122. These templates also help to make configuring large resources easier for Administrators. The software-defined resources include templates, profiles, and groups to provide an innovative way to manage a datacenter. These are logical constructs that allow an Administrator to specify the desired configuration of the wished environment and then let the datacenter manager automate the process of creating it. Groups and templates enable an Administrator to define configurations that are specific to the environment one wishes to build in, such as VMWare vSphere virtual hosts, Microsoft Exchange environments, Web servers, etc. These software-defined resources allow for the capture of best-practices from subject matter experts yet allows for customization with fast provisioning, great consistency, and fewer errors in setting up a desired configuration.

Server Profiles 134 and Enclosure Groups 162 make it easier to prepare a bare-metal server for operating system deployment, preparing the system with firmware, BIOS settings, local storage configurations, SAN storage, and network connectivity. Infrastructure Template Catalog 192 can be used to capture best practices once, and then roll them out multiple times in an efficient and error-free way. Further, the Server Profiles 134 can be used in conjunction with Operating System (OS) deployment tools to deploy hypervisor hosts from bare-metal and add them to existing clusters automatically. The virtual Server Profiles 134 are made up of Physical Resources 196 such as Server Hardware 158 that are housed in Racks 154 and Enclosures 160 in one or more Datacenters 156. The Enclosures 160 may be further combined into Enclosure Groups 162.

The Storage Volume Templates 120 allow the Administrator to access Logical Resources 194, Physical Resources 196, and Physical Resource Types 198. The logical resources 194 are virtually created instances of storage, servers, and networks that allow for software-defined resources provisioned as needed and include Storage Volumes 130, Volume Attachments 132, and Server Profiles 132. The Logical Storage Volumes 140 are defined using Physical Resources 196, such as Storage Pools 150 and Storage Arrays 152.

The Connection Templates 122 similarly allow the Administrator to access Logical Resources 194, physical resources 196 and Physical Resource types 198. The Connection Templates 122 allow for the capture of best practices for network configurations and how the bring together Network Sets 138, Networks 140 and Connections 136 that are Logical Resources 194. The Networks 140 are made up of Physical Resources 196 such as Switches 164 and Interconnects 166 which interface to the various Server Enclosures 160. The Networks 140 may also interface with physical Logical Interconnects 170 which connect to Logical Interconnect Groups 168 that further connect to server Enclosure Groups 162.

There may be several different types of hardware available for the storage, servers, enclosures, and networks in Physical Resource Types 198. These may be accessed via the Storage Array Types 180, Server Hardware Types 182, Enclosure Type 189, and Interconnect Types 186 ReST API functions.

These various resources available allow the datacenter configuration manager 110 to allow for managing infrastructure as a pool of resources that can be dynamically allocated. The infrastructure is abstracted from the underlying hardware components using hypervisors. The Administrator can provision datacenter or cloud infrastructure (compute nodes, storage nodes, controller nodes, etc.) dynamically from pools of physical infrastructure using a boot-strap configuration utility appliance 60 and a flat configuration data file 80 to define the desired infrastructure in a simple, convenient, and human-readable format.

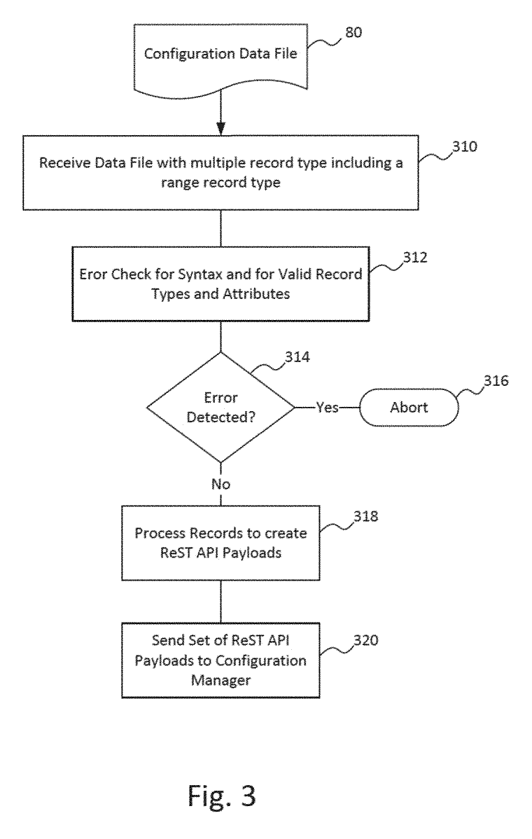

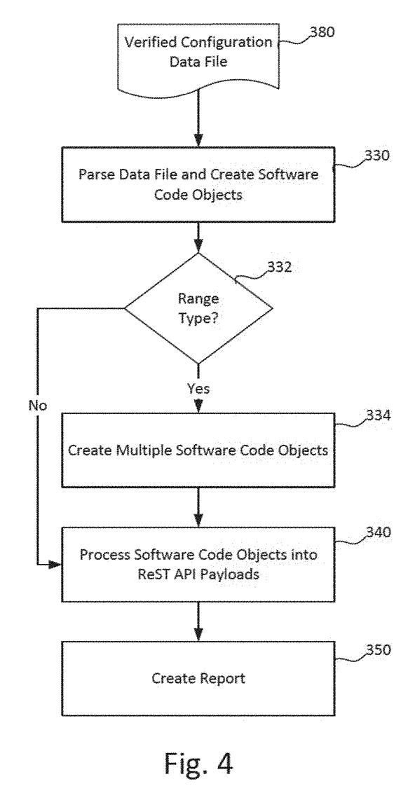

FIG. 3 is a flow chart of an example process in which to implement the BSCU utility 60. A desired configuration data file 80 is received by the datacenter configuration manager 110. The configuration data file 80 contains multiple record types including at least one range-record type in block 310. Then in block 312, the configuration data file 80 is error checked to verify that the proper syntax is used, both for the encoding such as XML and for the record type format. Also, the error checking examines the information provided in the data file to verify that any necessary attributes needed to process a respective ReST API request are provided. In decision block 314, if an error occurs in block 312 it is flagged and that error flag is checked to see if an error was detected. If at least one error did occur, the processes is aborted in block 316. If desired a report or log file can be created to help the Administrator determine the reason for the error. By not proceeding when an error occurs, the overall integrity of the datacenter can be protected by not having partially configured, or incorrectly configured situation present, which may occur during manual configuration or by application programming and debugging. In block 318, the multiple record types are processed (see FIG. 4) to create the ReST API payloads. In block 320, the BSCU utility 80 then sends the complete set of ReST API payloads to the datacenter configuration manager 320.

FIG. 4 is an example implementation of a sub-routine to create the ReST API payloads. In block 380, a verified configuration data file 380 is received. As it has previously been checked for errors, this sub-routine can be simplified and optimized to process the multiple record types efficiently. In block 330, the verified configuration data file is parsed to detect the various record types and their respective parameters and options. For each record type, a routine is called to create software code objects. For example, the Python programming language could be used and a python module would parse the configuration data file and create Python objects which may be combinations of data and/or procedures. Other alternative object code languages such as PHP, Ruby, Java, C++, etc. can be used in place of or in addition to the Python language. In block 340, the python code would then process the Python objects (or for other languages their respective objects) to create the ReST API payloads. In block 350, if desired a report can be created to list the various ReST API payloads and the final configuration of the datacenter configuration instance.

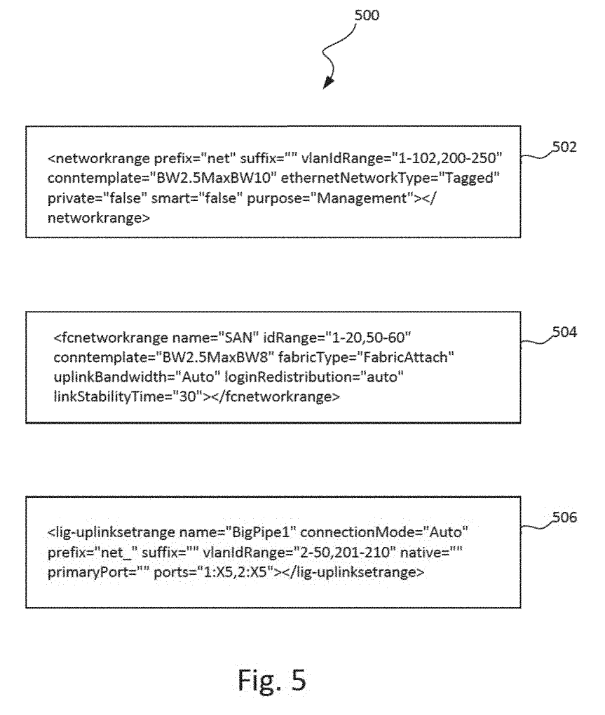

FIG. 5 is a set of example “range” element types 500 that can be further used to reduce the amount of information required to be submitted by the Administrator thereby further increasing efficiency and speed initial setup. For instance, first network element type 502 is used to setup a network range. As shown in FIG. 2, there may be many devices on the datacenter network and each must have at least one unique identifying network address. Rather than having to type in each network address for each device along with similar configuration information, the inventors have created a “range” element type such that multiple ReST API payloads will be created when a range parameter is supplied such as ‘vlanIdRange=“1-102, 200-250”’ in first network element type 502, ‘idRange=“1-20, 50-60”’ in second network element type 504 and ‘vlanIdRange=“2-50, 201-210”’ in third network element type 506. While network type ranges have been shown as examples, the range element type parameter can be used for other datacenter configuration parameters where there are a series of sequential numbers or names in the desired element type to be set up.

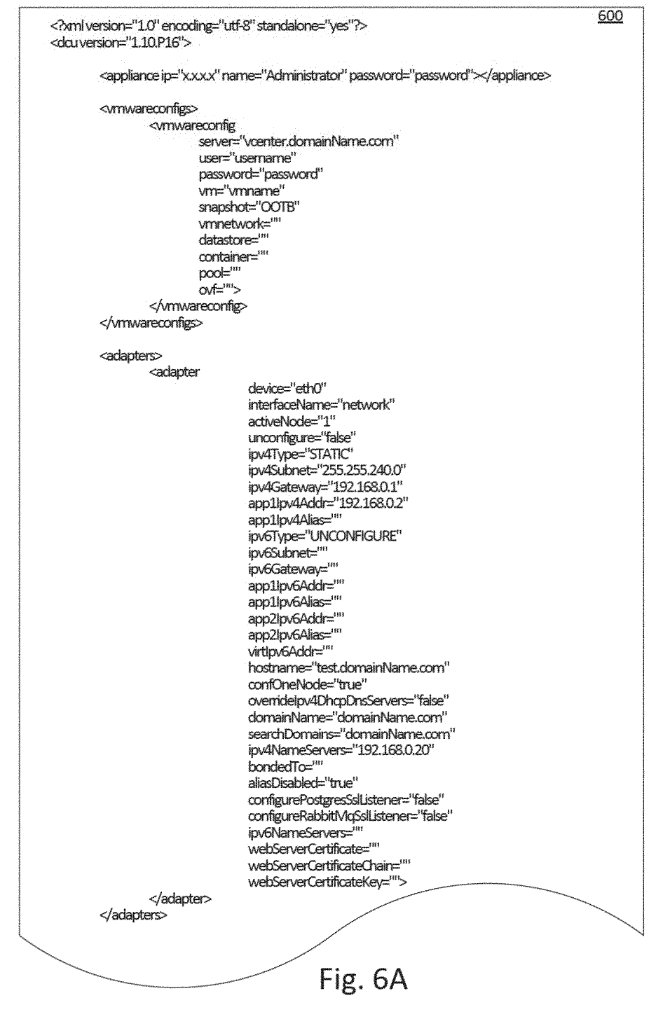

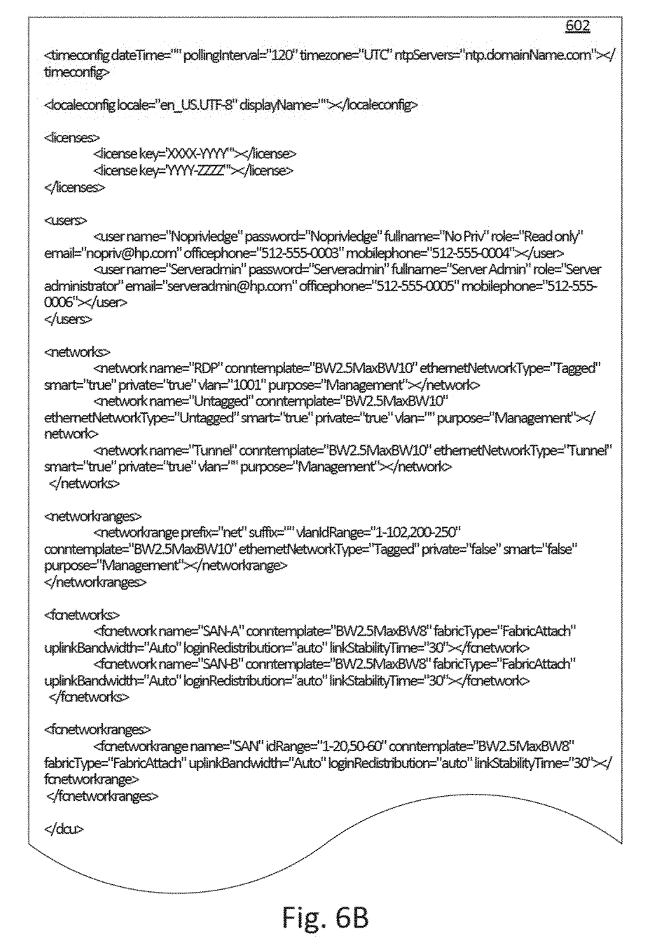

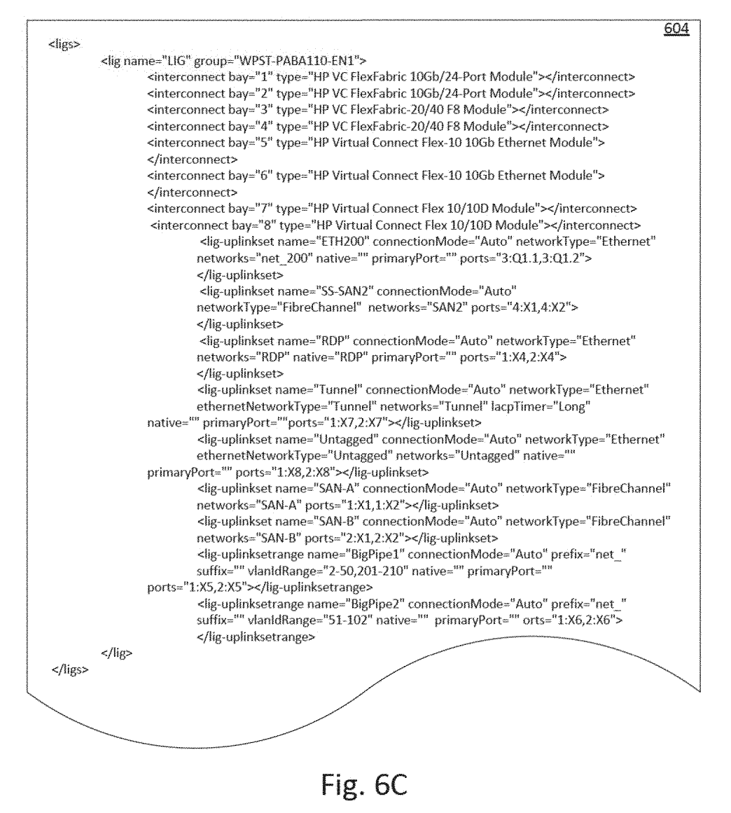

FIGS. 6A and 6B are example listings of some parameters which may be set up in a BSCU data file 80 format, illustrating syntax, structure, and human-readability. In fact, for a particular datacenter implementation, a BSCU data file 80 may be provided in a template fashion such that each of the required and optional elements are listed and default, dummy, or empty values are provided and the Administrator need only edit those required to setup the desired datacenter configuration. A more complete listing of the examples in FIGS. 6A and 6B can be found in the appendix.

FIG. 6C is an example data file 604 defining a logical interconnection group (lig) which is one of the more complex datacenter configurations to manage. As can be seen in FIG. 6C, the format is very human readable and relatively compact for the information required to configure the lig. In the appendix is an example listing of the generated ReST API payload request body for the data file definition found in FIG. 6C. Here the generated ReST API payload is far larger, nor human-readable as Administrators would normally describe a datacenter configuration. The organization and format in the generated payload is done to improve the communication between ReST API interface layers on the network rather than improve communication and understanding with the human Administrator.

The BSCU appliance program is consequently a datacenter infrastructure management system that is platform independent and data driven solution. This program and data file allows Administrators to quickly and effectively work with textual data that they are accustomed to rather than having to learn complex ReST API protocols, various programming quirks, and requirements to make the ReST API protocol operate properly. The BSCU appliance program thereby significantly decreases the overall deployment time necessary to set up a new datacenter configuration.

Accordingly, a method to configure a server system in a data center includes receiving a data file having one or more record types including at least one range record type. The data file is error-checked to verify the syntax is correct and that each of the one or more record types is valid and contains any required attributes. If either the syntax is incorrect or any of the one or more record types is not valid or any required attributes are missing, an error flag is set and the method is aborted to prevent misconfiguring the datacenter. However, if no error flag has been set, each record type is processed to create a set of ReST API payloads. The processing of each record may include creating software code objects as intermediaries. These object intermediaries are then processed to create the set of ReST API payloads. The set of ReST API payload are then sent to a data center configuration manager. In addition, a report containing all the ReST API payloads and their respective responses from the data center configuration manager can be created and saved or presented to the Administrator or other person desiring to configure the datacenter. This method may be encoded into computer readable media using instructions to be executed on a processor such as to be performed on a server within a datacenter, outside of the datacenter or on any computer, such as a personal computer, workstation, thin-client, cell phone, or tablet that has a network or other communication interface with the datacenter. There is no need for large storage or processing requirements as no programming is needed, just simply editing of a simple text file. Such editing tools are commonly provided on most computing platforms. Thus, there may be an editor processor generally available to create the data file in human-readable form thereby only requiring a minimal set of information to set up the server systems in the datacenter.

Accordingly, a system and method that can be implemented in computer readable media have been described which pertain to a boot-strap configuration utility (BSCU). The system is platform independent, data driven, and provides an Administrator the capability to describe a data center configuration in a flat file and apply the configuration to the management application (e.g., HP OneView) via a ReST interface. The BSCU saves the administrator the manual execution time and/or the development time required to create a custom integration solution, which allows the administrator to deploy their configuration faster than current available methods.

While the present BSCU appliance program has been particularly shown and described with reference to the foregoing preferred and alternative embodiments, those skilled in the art will understand that many variations may be made therein without departing from the spirit and scope of the BSCU appliance program as defined in the following claims. This description of the BSCU appliance program should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

### Example Generated ReST API Payload Request Body for the Definition in FIG. 6C

{“status”: null, “description”: null, “uplinkSets”: [{“networkUris”: [“/rest/ethernet-networks/bed30ea1-c41 a-4eaf-b346-d4d390a0a956”], “ethernetNetworkType”: “Tagged”, “name”: “ETH200”, “lacpTimer”: “Short”, “primaryPort”: null, “nativeNetworkUri”: null, “reachability”: null, “mode”: “Auto”, “networkType”: “Ethernet”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “3”}, {“type”: “Port”, “relativeValue”: “17”}]}}, {“desiredSpeed”: “Auto”, “logicalLocation”: {“locationEntries”: [{“type”: “Enclosure”, “relativeValue”: 1}, {“type”: “Bay”, “relativeValue”: “3”}, {“type”: “Port”, “relativeValue”: “18”}]}}]}, {“networkUris”: [“/rest/fc-networks/5194ae51-2483-495d-87ff-b3fe86ed4937”], “name”: “SS-SAN2”, “reachability”: null, “mode”: “Auto”, “networkType”: “FibreChannel”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “4”}, {“type”: “Port”, “relativeValue”: “33”}]}}, {“desiredSpeed”: “Auto”, “logicalLocation”: {“locationEntries”: [{“type”: “Enclosure”, “relativeValue”: 1}, {“type”: “Bay”, “relativeValue”: “4”}, {“type”: “Port”, “relativeValue”: “34”}]}}]}, {“networkUris”: [“/rest/ethernet-networks/c72d6a4d-ce57-4f93-8e19-77cd254e1be2”], “ethernetNetworkType”: “Tagged”, “name”: “RDP”, “lacpTimer”: “Short”, “primaryPort”: null, “nativeNetworkUri”: “/rest/ethernet-networks/c72d6a4d-ce57-4f93-8e 19-77cd254e1 be2”, “reachability”: null, “mode”: “Auto”, “networkType”: “Ethernet”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “1”}, {“type”: “Port”, “relativeValue”: “20”}]}}, {“desiredSpeed”: “Auto”, “logicalLocation”: {“locationEntries”: [{“type”: “Enclosure”, “relativeValue”: 1}}, {“type”: “Bay”, “relativeValue”: “2”}, {“type”: “Port”, “relativeValue”: “20”}]}}]}, {“networkUris”: [“/rest/ethernet-networks/b1cfc0c9-eb67-4faa-9fb5-b74e51 ea96ab”], “ethernetNetworkType”: “Tunnel”, “name”: “Tunnel”, “lacpTimer”: “Long”, “primaryPort”: null, “nativeNetworkUri”: null, “reachability”: null, “mode”: “Auto”, “networkType”: “Ethernet”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “1”}, {“type”: “Port”, “relativeValue”: “23”}]}}, “desiredSpeed”: “Auto”, “logicalLocation”: {“locationEntries”: [{“type”: “Enclosure”, “relativeValue”: 1}, {“type”: “Bay”, “relativeValue”: “2”}, {“type”: “Port”, “relativeValue”: “23”}]}}]}, {“networkUris”: [“/rest/ethernet-networks/f43d6d01-caa9-4830-98b3-3dc3d5d15b9c”], “ethernetNetworkType”: “Untagged”, “name”: “Untagged”, “lacpTimer”: “Short”, “primaryPort”: null, “nativeNetworkUri”: null, “reachability”: null, “mode”: “Auto”, “networkType”: “Ethernet”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “1”}, {“type”: “Port”, “relativeValue”: “24”}]}}, {“desiredSpeed”: “Auto”, “logicalLocation”: {“locationEntries”: [{“type”: “Enclosure”, “relativeValue”: 1}, {“type”: “Bay”, “relativeValue”: “2”}, {“type”: “Port”, “relativeValue”: “24”}]}}]}, {“networkUris”: [“/rest/fc-networks/50e4d0ef-1bf5-4ef2-bc81-b68c85b18e19”], “name”: “SAN-A”, “reachability”: null, “mode”: “Auto”, “networkType”: “FibreChannel”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “1”}, {“type”: “Port”, “relativeValue”: “17”}]}}, {“desiredSpeed”: “Auto”, “logicalLocation”: {“locationEntries”: [{“type”: “Enclosure”, “relativeValue”: 1}, {“type”: “Bay”, “relativeValue”: “1”}, {“type”: “Port”, “relativeValue”: “18”}]}}]}, {“networkUris”: [“/rest/fcnetworks/7c07cbdb-b03e-4b59-b032-fd4fe0f6d0aa”, “name”: “SAN-B”, “reachability”: null, “mode”: “Auto”, “networkType”: “FibreChannel”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “2”}, {“type”: “Port”, “relativeValue”: “17”}]}}, {“desiredSpeed”: “Auto”, “logicalLocation”: {“locationEntries”: [{“type”: “Enclosure”, “relativeValue”: 1}, {“type”: “Bay”, “relativeValue”: “2”}, {“type”: “Port”, “relativeValue”: “18”}]}}]}, {“networkUris”: [“/rest/ethernet-networks/5820fb58-11bb-48ed-9eaa-af5be9f8e1ca”, “/rest/ethernet-networks/6d34fa19-da04-49a3-a4f5-be8c7a1c1e88”, “/rest/ethernet-networks/549fca5a-8669-4e8c-853c-55a90e39031a”, “rest/ethernet-networks/22cb083c-89f8-4649-98fa-3a0c147421c9”, “/rest/ethernet-networks/3b381d72-cc1c-4310-9b56-d0aee337dcf2”, “/rest/ethernet-networks/73bc825f-89ac-4c9d-8a51-dfa4835d8924”, “/rest/ethernet-networks/93ef814f-d295A46f6-bf83-b4f395b2bef7”, “/rest/ethernet-networks/a5551dcd-1921-4eca-a258-677ddd6b4075”, “/rest/ethernet-networks/bef5e33d-cf20-499a-850f-10c5ce635e69”, “/rest/ethernet-networks/88c933b5-a1 bc-460a-803b-2be933da8d54”, “/rest/ethernet-networks/66fb96c9-b1eb-A270-9b48-e14e7ce25a6d”. “rest/ethernet-networks/f7dcc044d438-4a44-a4e2-d30d7c ce5d03”, “/rest/ethernet-networks/2e2b002a-539a-47a0-a918-e7ba127ebe8a”, “/rest/ethernet networks/66bb88db-1f4f-4722-864d-20349ef95fc5”, “/rest/ethernet-networks/af6e9002-601 d-4ff3-bf39-0a95b34dcac3”, “/rest/ethernet-networks/ae64901d-534f-411b-b888-996253f517d7”, “/rest/ethernet-networks/0ba590ff-7e01-4134-bf78-97251eef73b1”, “/rest/ethernet-networks/e4add5ea-05bc-4c42-9ec6-4998d0074eba”, “/rest/ethernet-networks/963c673a-9485-4cee-9b25-dfb58981c860”, “/rest/ethernet-networks/4bc82630-a8ab-4107-8b4d-71ad46b2d391”, “/rest/ethernet-networks/38aa4b12-36b5-47ab-896e-3a81adb5b612”, “/rest/ethernet-networks/a42605ba-bbc6-419f-8535-5fc4bbf60bf7”, “/rest/ethernet-networks/d52fa207-baba-4217-ba6e-50dadface884”, “/rest/ethernet-networks/2736152b-29ff-4428-88db-94bf252f04a7”, “/rest/ethernet-networks/00045afd-dc38-4503-a526-4f1ec0f84f83”, “/rest/ethernet-networks/4c18201f1-7835-46d8-970e-413c353eaa43”, “rest/ethernet-networks/839faccd-77f4-4929-ae6f-438e9a8e14eb”, “/rest/ethernet-networks/6edccd24-9b0e-4872-b35d-e4f82e5fa641”, “/rest/ethernet-networks/c6d06a95-17ec-48c4-8e59-0461 e4ff6575”, “/rest/ethernet-networks/f7fd10b3-ea92-4201-a2ee-3f3db9e72e5a”, “/rest/ethernet-networks/aefb8e70-b78d-40d2-a6ad-0f66f4f1bb77”, “/rest/ethernet-networks/f3857d24-b632-40fb-bb35-06b7a6c7e6bb”, “/rest/ethernet-networks/c6839fe2-a8ce-42b5-a1eb-b3cbbbed9bba”, “/rest/ethernet-networks/596b1a6b-b85b-4f16-a85d-e05376b425db”, “/rest/ethernet-networks/f11ab0d-00ef-428f-a3a6-fd7e10a45b3f”, “/rest/ethernet-networks/c8bd66db-04fc-4fbd-bdc1-457172e05525”, “/rest/ethernet-networks/1a82518e-e1c7-473f-8556-9c192f46390b”, “/rest/ethernet-networks/32583584ec61-42b2-be28-2e26748b8dc6”, “/rest/ethernet-networks/1d4397d9-35a1-4de7-ad05-b527b45a6a18”, “/rest/ethernet-networks/8cf2601e-bd90-4393-9858-d214fd6dcec5”, “/rest/ethernet-networks/d67637e9-666e-429c-8625-be022b98cff3”, “/rest/ethernet-networks/608cb630-96cb-40f-916b-29390acb790c”, “/rest/ethernet-networks/6b27e2ec-b0dc-4f78-9t0a-44b455169487”, “/rest/ethernet-networks/e0cd9959-3027-4b18-bc16-cd873ce645c4”, “/rest/ethernet-networks/b9f01b81-9a8c-4236-a839-84e1fbccbf93”. “/rest/ethernet-networks/3ec2c083-dad1-4ba5-b903-338a395b01f6”, “/rest/ethernet-networks/6698f0d3-de82-48e8-a8c4-dbcdc97c1e48”, “/rest/ethernet-networks/75f84088-e7ec 4989-9d1f-074b46d7bfdb”, “/rest/ethernet-networks/5f7b1be2-5c2d-483f-8e37-7b8e95fdbed8”, “/rest/ethernet-networks/a94d3adb-5d74-4f9a-91d1-a256915d6a26”, “/rest/ethernet-networks/5bb15t0e-825-435a-828f-5baeaf4a99cb”, “/rest/ethernet-networks/8bce81cf-55bc-4059-91cf-ea833d3a8b82”, “/rest/ethernet-networks/34d368a4-cce7-46b1-b1b3-414de2fe2a6d”, “/rest/ethernet-networks/b7c3c308-3690-4a31-b143-38f848826e7e”, “/rest/ethernet-networks/ff48915f-8879-4132-9ea5-ff322a48e2ef”, “/rest/ethernet-networks/a9a11fa7-8afc-40ac-998a-39a3ad8e6324”, “/rest/ethernet-networks/4901f1f8-eef0-4c20-922c-4278538bab73”, “/rest/ethernet-networks/b2324810-299d-4348-b968-e859353c4a4b”, “/rest/ethernet-networks/1c114c6a-f19c-41c8-9dbc-0e67ef6252ff”], “name”: “BigPipe1”, “nativeNetworkUri”: null, “reachability”: null, “mode”: “Auto”, “networkType”: “Ethernet”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “1”}, {“type”: “Port”. “relativeValue”: “21”}]}}, {“desiredSpeed”: “Auto”, “logicalLocation”: {“locationEntries”: [{“type”: “Enclosure”, “relativeValue”: 1}, {“type”: “Bay”, “relativeValue”: “2”}, {“type”: “Port”, “relativeValue”: “21”}]}}]}, {“networkUris”: “/rest/ethernet-networks/fae85604-e8da-425-8a8d-172e512942d3”, “/rest/ethernet-networks/2f495f8d-d692-42ac-85cca6cbb911f069”, “/rest/ethernet-networks/f1bc4fc5-117b-4786-ae41-5205779cbbfe”, “/rest/ethernet-networks/4cb441 a3-fbec-4aa5-8c7c-2f329d8f28af”, “/rest/ethernet-networks/5a3ff1e2-9d2c-49b3-b023-6bc9f8e212ab”, “/rest/ethernet-networks/2182f8ed-8551-48b1-838b-5c65ca9b9ba5”, “/rest/ethernet-networks/3b8bab6f-ef59-452c-b0e2-cf35861049b4”, “/rest/ethernet-networks/8efbd739-1d67-4480-a6c3-8098f7d 18e3d”, “/rest/ethernet-networks/173c0f85-919b-4f5e-9a26-60f5c0223e2f”, “/rest/ethernet-networks/301dcb05-32df-4352-be76-51 dedd670S06”, “/rest/ethernet-networks/e32b6739-f9be-4b6c-8f61-909851 a93609”, “/rest/ethernet-networks/fb687551-dd8c-4124-b949fb090710bebe”, “/rest/ethernet-networks/965f5b94-de8d-4f77-bc3c-d4782b578775”, “/rest/ethernet-networks/59f650fb-1e94-434f-9813-db01a7885b89”, “/rest/ethernet-networks/e99a2823-ac11-267-bfb6-d38bd2f8556c”, “/rest/ethernet-networks/cea2ea7-7c92-4031-9012-03c4f0f08653”, “/rest/ethernet-networks/e19a0180-3456-4219-a8f8-aad293dbb1c”, “/rest/ethernet-networks/635c1731-9d9e-4492-99b9-3ab95d6f1476”, “/rest/ethernet-networks/715af0d6-1448-4894-be5c579123c439ba”, “/rest/ethernet-networks/ac5e65f4-150b-4766-b4eb-0698a9f4ed0d”, “/rest/ethernet-networks/1525aa32-2efd-4680-a220-abd4757c53b4”, “/rest/ethernet-networks/e1ed3f2b-7631-44b7-a82b-f391 a7d50aad”, “/rest/ethernet-networks/fbe2ae3b-da2f-4ec6-a07e-a231aa97a2fb”, “/rest/ethernet-networks/24d12a45-da3a-47dd-8715-69127c385336”, “/rest/ethernet-networks/ec77380e-9c60-47a b-b9c9-b 1ec1a c489fd”, “/rest/ethernet-networks/c7dc8294-3cd0-4861-9504-986d90cbc1aa”, “/rest/ethernet-networks/259cf0b-40e7-4aca998-6294ffc1be7”. “/rest/ethernet-networks/4a610ad6-ebbb-4ba4-b997-15af429b015b”, “/rest/ethernet-networks/624de7e7-41d7-4347-bb62-6cd7fa102ea11”, “/rest/ethernet-networks/30d33833-4567-4103-8dce-3b3e39e05ab6”, “/rest/ethernet-networks/b65ff641-1tec-b4a-934d-4ca4aa72936b”, “/rest/ethernet-networks/cbd2e69c-a009-4925-9cec-3b51cb11b7f07”, “/rest/ethernet-networks/15a25d5f-75b9-44ac-837f-528034851984”, “/rest/ethernet-networks/f4cf23a5-9d27-430c-970f-51e608b1fe57”, “/rest/ethernet-networks/a310d978-c14a-40a6-83a4-8eba43352c83”, “/rest/ethernet-networks/6f905a5f 75ca-41b2-b101-5f9ad7851e35”, “/rest/ethernet-networks/60e23e78-130b-4f61-ab67-2abdfdd2f9f6”, “/rest/ethernet-networks/fafc4e22-f625-4ce0-a1b6-75c58587d759”, “/rest/ethernet-networks/a3e5691f-11fa-4410-a94f-051 a7fb81d35”, “/rest/ethernet-networks/7d845d7d-ddc4-4172-9cb8-d97bf72093f3”, “/rest/ethernet-networks/614de7e4-9983-4f9f-a55d-ecc5db363119”, “/rest/ethernet-networks/6d408fc1-5055-4fa8-a0ed-b19a62aad88f”, “/rest/ethernet-networks/ca65d49e-cb111-4d04-95a0-996a852383bb”, “/rest/ethernet-networks/9aba246b-b661-48af-b70f-1bb5cd0ec36d”, “/rest/ethernet-networks/32737aaa-5d94-4c8-9eaa-1d61707fd05c”, “/rest/ethernet-networks/094765ba-2e26-4ebe-963a-ee52b6b864e9”, “/rest/ethernet-networks/ad2df966-9982-4c82-b042-28e067b4fd30”, “/rest/ethernet-networks/f9e1f074-e5c2-4714-bf6e-285cdf14bb5f”, “/rest/ethernet-networks/9b98b851-4d06-4734-970f-926a32c642fc”, “/rest/ethernet-networks/16f423a1-5a3b-4454-bb84-36bc06769b65”, “/rest/ethernet-networks/9e65e99-870-4aa2-9243-01760617ace2”, “/rest/ethernet-networks/48e3b518-4e19-4a46-a592-36351cd23be2”], “name”: “BigPipe2”, “nativeNetworkUri”: null, “reachability”: null, “mode”: “Auto”, “networkType”: “Ethernet”, “logicalPortConfigInfos”: [{“desiredSpeed”: “Auto”, “logicalLocation”: {“locationEntries”: [{“type”: “Enclosure”, “relativeValue”: 1}, {“type”: “Bay”, “relativeValue”: “1”}, {“type”: “Port”, “relativeValue”: “22”}]}}, {“desiredSpeed”: “Auto”, “logicalLocation”: {“locationEntries”: [{“type”: “Enclosure”, “relativeValue”: 1}, {“type”: “Bay”, “relativeValue”: “2”}. {“type”: “Port”, “relativeValue”: “22”}]}}]}], “uri”: null, “eTag”: null, “stackingHealth”: null, “stackingMode”: null, “category”: null, “name”: “LIG”, “created”: null, “modified”: null, “state”: “Active”, “interconnectMapTemplate”: {“interconnectMapEntryTemplates”: [{“logicalDownlinkUri”: null, “logicalLocation”: {“locationEntries”: [{“type”: “Enclosure”, “relativeValue”: 1}, {“type”: “Bay”, “relativeValue”: 1}]}, “permittedInterconnectTypeUri”: “/rest/interconnect-types/29c9981c-3f65-46c4-99b5-75410fef3692”}, {“logicalDownlinkUri”: null, “logicalLocation”: {“locationEntries”: [{“type”: “Enclosure”, “relativeValue”: 1}, {“type”: “Bay”, “relativeValue”: 2}]}, “permittedInterconnectTypeUri”: “/rest/interconnect-types/29c9981c-3f65-46c4-99b5-75410fef3692”}, {“logicalDownlinkUri”: null, “logicalLocation”: {“locationEntries”: [{“type”: “Enclosure”, “relativeValue”: 1}, {“type”: “Bay”, “relativeValue”: 3}]}, “permittedInterconnectTypeUri”: “/rest/interconnect-types/9705bea3-bcc0-4ad5-9d6e-3cc9f32ca383”}, {“logicalDownlinkUri”: null, “logicalLocation”: {“locationEntries”: [{“type”: “Enclosure”, “relativeValue”: 1}, {“type”: “Bay”, “relativeValue”: 4}]}, “permittedInterconnectTypeUri”: “/rest/interconnect-types/9705bea3-bcc04ad5-9d6e-3cc9f32ca383”}, {“logicalDownlinkUri”: null, “logicalLocation”: {“locationEntries”: [{“type”: “Enclosure”, “relativeValue”: 1}, {“type”: “Bay”, “relativeValue”: 5}]}, “permittedInterconnectTypeUri”: null}, {“logicalDownlinkUri”: null, “logicalLocation”: {“locationEntries”: [{“type”: “Enclosure”, “relativeValue”: 1}, {“type”: “Bay”, “relativeValue”: 6}]}, “permittedInterconnectTypeUri”: null}, {“logicalDownlinkUri”: null, “logicalLocation”: {“locationEntries”: [{“type”: “Enclosure”, “relativeValue”: 1}, {“type”: “Bay”, “relativeValue”: 7}]}, “permittedInterconnectTypeUri”: null}, {“logicalDownlinkUri”: null, “logicalLocation”: {“locationEntries”: [{“type”: “Enclosure”, “relativeValue”: 1}, {“type”: “Bay”, “relativeValue”: 8}]}, “permittedInterconnectTypeUri”: null}]}, “type”: “logical-interconnect-groupV2”}

What is claimed is:

1. A method of configuring a server system in a data center, comprising:
receiving a data file having one or more record types including at least one range record type;
error-checking to verify the data file has correct syntax and that each of the one or more record types is valid and contains any required attributes;
setting an error flag if either the syntax is incorrect or any of the one or more record types is not valid or required attributes are missing; and
if no error flag,
processing each record type to create a set of ReST API payloads; and
sending the set of ReST API payloads to a data center configuration manager.

2. The method of claim 1 wherein processing each record includes creating software code objects as intermediaries.

3. The method of claim 2 further comprising processing the object intermediaries to create the set of ReST API payloads.

4. The method of claim 1 further comprising creating a report containing all the ReST API payloads and their respective responses from the data center configuration manager.

5. The method of claim 1 further comprising, creating a data file in human readable form having a minimal set of information required to set up the server system.

6. A configuration system to configure a server system in a data center, comprising:
an input processor to receive a data file having multiple record types including a range record type;
an error checking processor to verify the data file has correct syntax and that each of the multiple record types is a valid record type with required attributes;
a record processor to convert each of the record types in the data file into a set of ReST API requests if no error was detected; and
an output processor to send the set of ReST API requests to a data center configuration manager if no error was detected.

7. The configuration system of claim 6 wherein the record processor first converts each of the record type in the data file to a set of software objects as an intermediaries.

8. The configuration system of claim 7 wherein the record processor converts the set of software objects to the set of ReST API requests.

9. The configuration system of claim 6 further comprising a report processor to create a report containing all the ReST API requests and their respective responses from the data center configuration manager.

10. The configuration system of claim 6 further comprising an editor processor to create the data file in human-readable form having a minimal set of information required to set up the server system.

11. A non-transitory computer readable memory (CRM), comprising instructions executable on a processor to:
receive a data file having multiple record types including a record type that allows for a range of values to be entered;
error check the data file to verify that syntax is correct and that each of the multiple record types is a valid record type with required attributes;
convert each of the multiple record types in the data file into a set of ReST API requests if the error check passed; and
send the ReST API requests to a data center configuration manager if the error check passed.

12. The CRM of claim 11 wherein the instructions are executable to first convert each of the multiple record types in the data file into a respective software object.

13. The CRM of claim 12 wherein the instructions are executable to convert the respective software objects into the set of ReST API requests.

14. The CRM of claim 11 further comprising instructions to create a report containing all the ReST API requests and their respective responses from the data center configuration manager.

15. The CRM of claim 11 further comprising instructions to create the data file in human readable form having a minimal set of information required to set up the server system.
